(19) United States
(12) Patent Application Publication
(10) Pub. No.: US 2004/0245293 A1
(43) Pub. Date: Dec. 9, 2004

(54) Adhesive dripping machine

(76) Inventors: Chin Ting Lor, Sinjhuang City (TW); Kuo-Lung David Lor, Sinjhuang City (TW); John Lor, Sinjhuang City (TW)

Correspondence Address: DENNISON, SCHULTZ,, DOUGHERTY & MACDONALD, SUITE 105, 1727 KING STREET, ALEXANDRIA, VA, 22314-2700, US

(21) Appl. No.: 10/860,099

(22) Filed: Jun. 4, 2004

(30) Foreign Application Priority Data
Jun. 6, 2003 (TW) 092210408

(51) Int. Cl. B67D 5/42

(52) U.S. Cl. 222/390

(57) ABSTRACT

An adhesive dripping machine, the machine can be used in a dustless operation environment, and comprises: a cylinder for receiving adhesive, a driving device provided above the cylinder, a material pusher piston provided in the cylinder and driven by the driving device to create axial displacement, and a controller for controlling the driving device. The components of the adhesive dripping machine are simplified for convenient carrying, the controller can control the driving device to move the material pusher piston to and fro in the cylinder. When the pusher piston is moved forwards, the adhesive can be extruded out under accurate control; when the pusher piston is retracted, the adhesive does not further drip; by controlling the pusher piston in displacing for a fixed distance, the work of adhesive dripping can be accurately performed.

### BACKGROUND OF THE INVENTION

1. Field of the Invention

The present invention is related to an adhesive dripping machine, and especially to an adhesive dripping machine able to accurately control the amount of adhesive flow and can be used in a dustless operation environment. The machine is suitable to load liquid adhesive, UV adhesive, instant adhesive, silver adhesive etc. for the purposes of sticking, sealing, fixing, covering and filling etc. in various industries.

2. Description of the Prior Art

Following nonstop advancement of the society, people require more and more on the quality of articles, particularly on the strengthening of interior structures, and the protection of exterior appearances; hence various adhesives (such as ultraviolet-ray adhesive, instant adhesive etc.) are used to make mutual sticking of various materials, and some use adhesives for the purposes of sticking, sealing, fixing, covering and filling etc. in various industries, to strengthen interior structures and protect exterior appearances.

Generally a conventional technique uses an adhesive dripping machine 1 (as shown in FIG. 1) to control adhesive dripping and amount of outputting flow of adhesive 2, its power source is an air compressor 3. The air compressor 3 compresses and delivers air to a controller 4, the controller 4 adjusts the air pressure to drive a piston 6 in a material receiving barrel 5 to extrude the adhesive 2 out of a nozzle 7. The above stated structure though have the effect of adhesive dripping; it has the following defects:

1. Because the adhesive dripping machine pushes the piston and controls the flow of the adhesive, when the piston is pushed forwards, the distance of the piston from the outlet of the compressed air gets longer and longer. This correspondingly makes the force of pushing the piston smaller and smaller, the outputting amount of the adhesive is affected and hard to be accurately controlled.

2. A conventional adhesive dripping machine includes an air compressor and a controller. The volume of the air compressor is larger and has quite large weight. Thereby space needed for the machine is large, and the machine is inconvenient for carrying.

3. The controller of the above stated adhesive dripping machine has an air outlet for adjustment of air pressure. When it is to release pressure, waste gas is exhausted from the air outlet. Therefore, the adhesive dripping machine is unable to operate in a dustless environment.

In view of the above defects to be solved for ensuring that an adhesive dripping machine not only can be convenient for carrying, but also can accurately control the flow of the adhesive and further can be used in a dustless environment, the inventor provides the present invention based on his professional experience of years in nonstop studying and development.

### SUMMARY OF THE INVENTION

The primary object of the present invention is to provide an adhesive dripping machine that can accurately control the amount of adhesive flow by controlling a material pusher piston to make displacement for a fixed distance, this can allow an effective work of adhesive dripping.

The secondary object of the present invention is to provide an adhesive dripping machine that can prevent generation of waste gas by combining of electric and mechanical means, so that the machine can be used in a dustless operation environment.

Therefore, in order to achieve the above objects, the adhesive dripping machine provided in the present invention comprises: a cylinder for receiving liquid material, the upper end of the cylinder has a first engaging portion, and its bottom end has a material outlet nozzle; a driving device provided above the cylinder and having a second engaging portion engaged with the first engaging portion; a material pusher piston provided in the cylinder and having a link on one end thereof, the piston is driven by the driving device to create axial displacement in the cylinder; and a controller electrically connecting with the driving device. With the above combination, the controller can control the driving device to make the material pusher piston move frontwards and rearwards in the cylinder. When the material pusher piston moves forwards, the liquid material in the cylinder can be extruded out of the outlet nozzle; when the material pusher piston is retracted rearwards, by attraction of the piston, the liquid material will not go on to drip down. By controlling the material pusher piston to displace for a fixed distance, the work of adhesive dripping can be accurately performed.

The present invention will be apparent after reading the detailed description of the preferred embodiment thereof in reference to the accompanying drawings.

### BRIEF DESCRIPTION OF THE DRAWINGS

FIG. 1 is a perspective view showing the appearance of a conventional adhesive dripping machine;

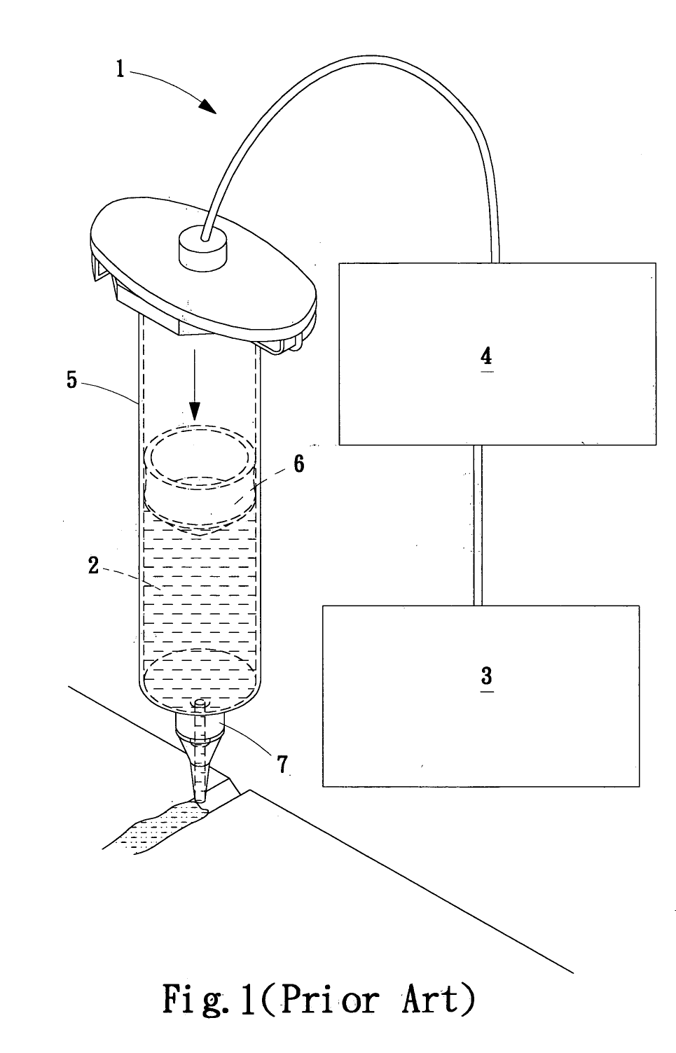

FIG. 2 is a perspective view showing the appearance of a first embodiment of the present invention;

FIG. 3 is analytic perspective view showing the elements of the first embodiment of the present invention;

FIG. 4 is a sectional view showing the assembly of the first embodiment of the present invention;

FIG. 5 is a sectional view showing a state that a piston of the first embodiment of the present invention moves forwards;

FIG. 6 is a sectional view showing a state that the piston of the first embodiment of the present invention retracts rearwards;

FIG. 7 is a sectional view showing the assembly of a second embodiment of the present invention;

FIG. 8 is a sectional view showing the assembly of a third embodiment of the present invention.

### DETAILED DESCRIPTION OF THE PREFERRED EMBODIMENT

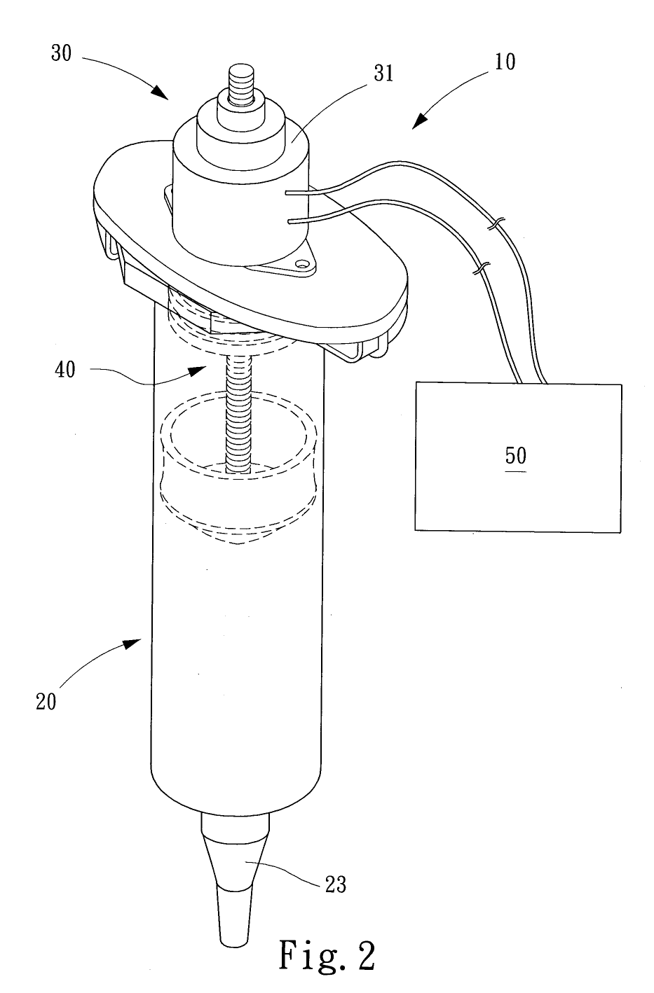

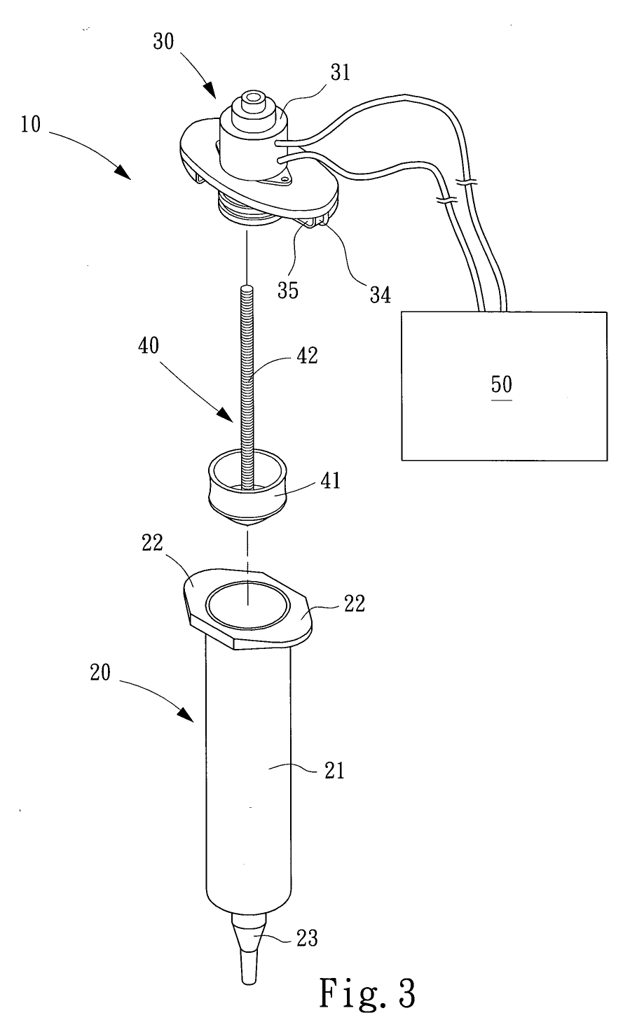

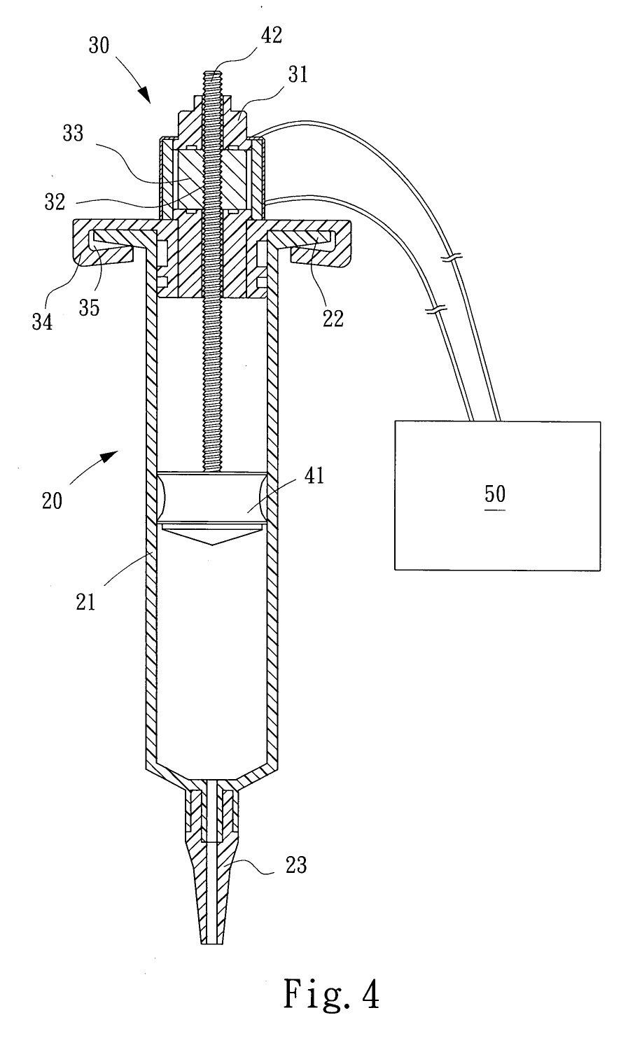

Referring firstly to FIGS. 2-4 showing the first embodiment of adhesive dripping machine 10 of the present invention, wherein a controller 50 controls the rotating rate and direction of a servomotor 31 of a driving device 30 to move a material pusher piston 40 forwards and rearwards in a material receiving cylinder 20, thereby adhesive can be extruded out in pursuance of the amount of the adhesive and the mode of adhesive dripping desired in operation; wherein:

the material receiving cylinder 20 is a hollow cylinder 21 for receiving adhesive (such as ultraviolet-ray adhesive, instant adhesive etc.), it is provided on the upper end thereof with two wings 22 forming a first engaging portion perpendicular to the hollow cylinder 21 and protruding outwards, and is provided on its bottom end with a material outlet nozzle 23;

the driving device 30 includes the servomotor 31, the servomotor 31 has therein a rotator 33 provided with an inner screw thread 32, the rotator 33 is controlled by the controller 50 to create different modes of rotation in different directions, and to result in different rotation speeds because of different amounts of input electric currents; the bottom end of the servomotor 31 is connected to an engaging portion 34 served as a second engaging portion, the engaging portion 34 is provided on two lateral sides on the bottom end thereof with recesses 35 to be engaged with the two wings 22 on the upper end of the material receiving cylinder 20;

the material pusher piston 40 has a piston head 41 on one end thereof; the piston head 41 is provided in the material receiving cylinder 20 to tightly contact the inner wall of the latter, and the other end of the material pusher piston 40 is a link 42 (which is a screw rod in this embodiment), the screw rod 42 is screw connected with the inner screw thread 32 of the abovementioned rotator 33; when the rotator 33 is rotated in a clockwise or counterclockwise direction, the screw rod 42 is driven to displace frontwards and rearwards in the cylinder 20;

the controller 50 is electrically connected with the servomotor 31, and can adjust the outputting amount of electric current as well as the direction of outputting, and thereby can control the rotating rate and direction of the inner rotator 33 of the servomotor 31.

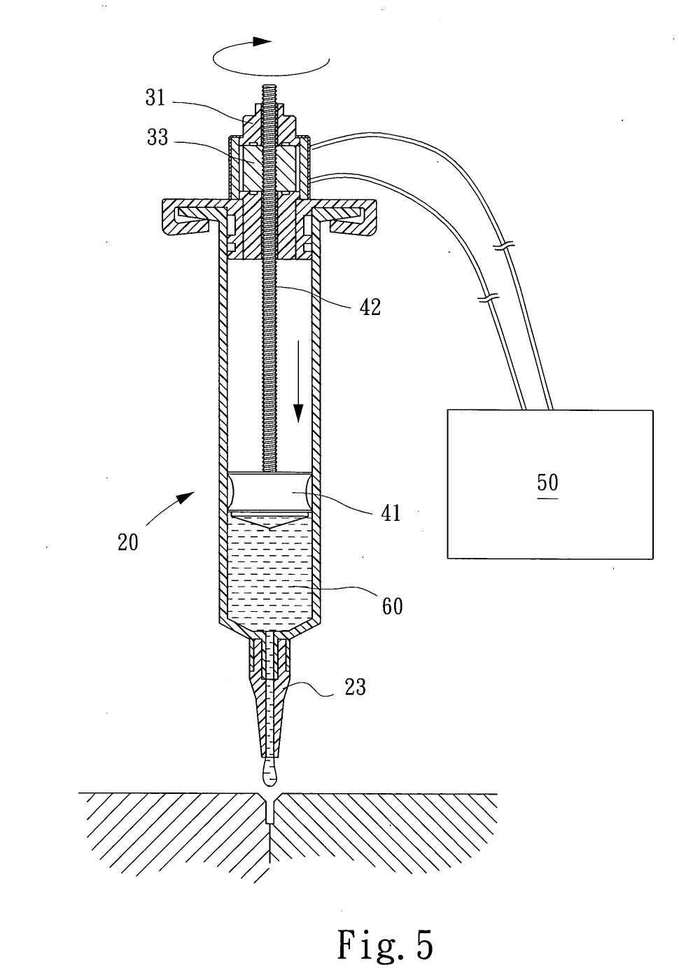

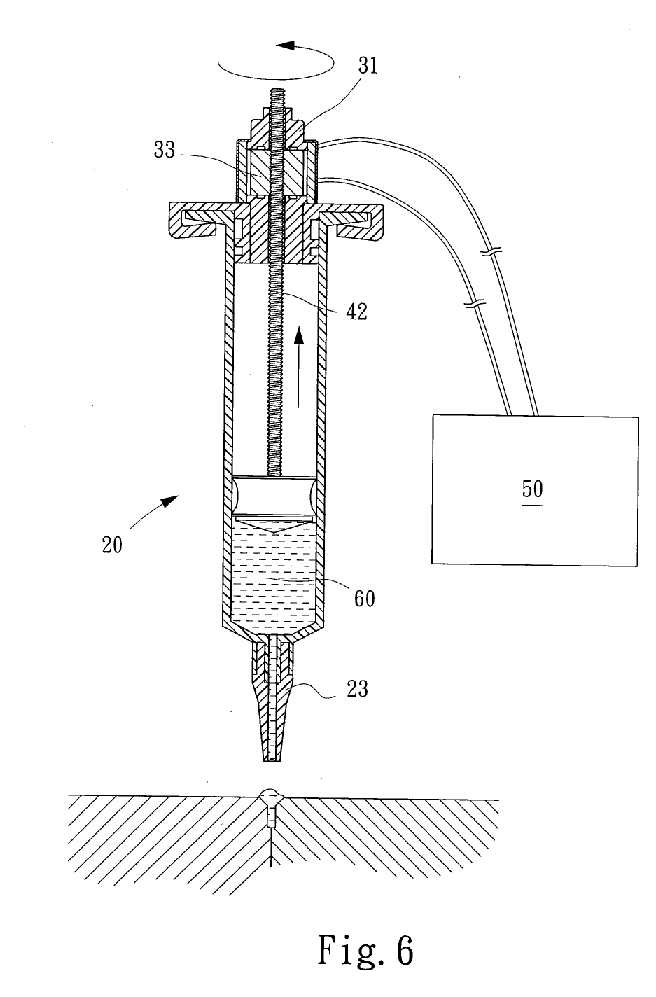

Referring to FIGS. 5 and 6, when the controller 50 controls currents to input into the servomotor 31 from various directions, the inner rotator 33 of the servomotor 31 rotates clockwise or counterclockwise to move the screw rod 42 to displace frontwards and rearwards axially; when the piston head 41 is moved frontwards, adhesive 60 in the material receiving cylinder 20 is extruded out of the material outlet nozzle 23; while when the piston head 41 is retracted rearwards, by attraction of the piston head 41, the adhesive 60 will not go on to drip down.

When the controller 50 inputs different amounts of electric currents into the servomotor 31, it can control the rotating rate of the inner rotator 33 of the servomotor 31, and in turn controls the speed of forwarding of the piston head 41. By virtue of the distance of displacement of forwarding the piston head 41 can be kept constant, when in adhesive dripping, the amount of adhesive from the beginning to finishing can be accurately controlled.

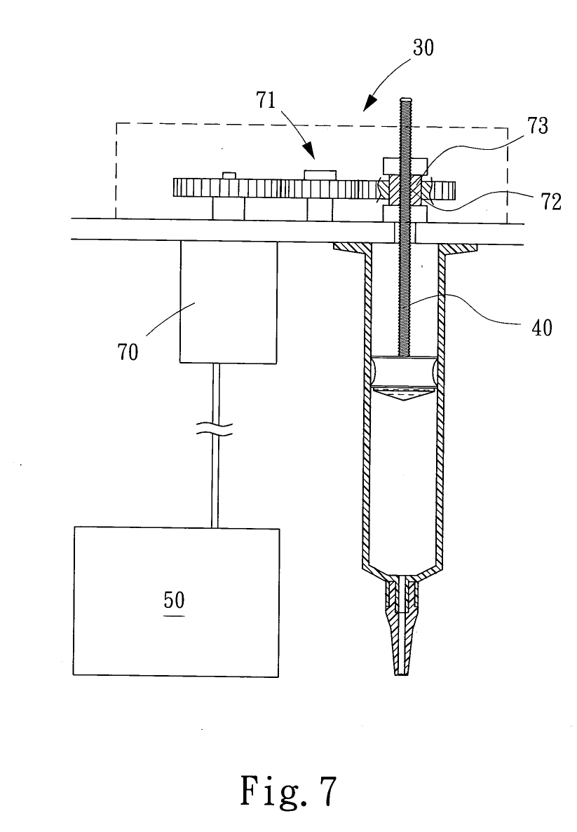

Referring to FIG. 7 showing the second embodiment of the present invention, wherein a driving device 30 has a servomotor 70 connecting with a controller 50 to provide outputs of different rotating speed; the servomotor 70 transmits power to a connecting rod 73 having an inner screw thread 72 by means of a gear set 71 to connect and drive a material pusher piston 40, thus results in the operation state same as that of first embodiment.

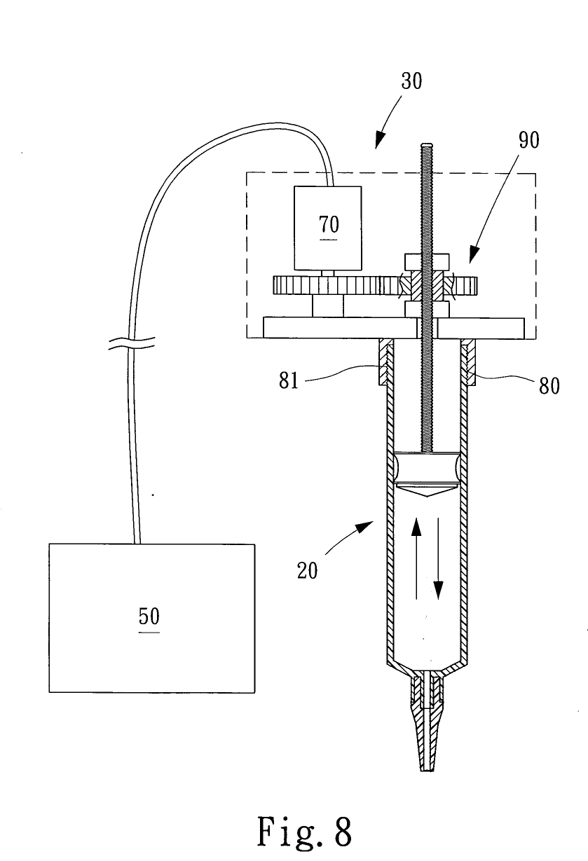

Referring to FIG. 8 showing the third embodiment of the present invention, wherein a gear set 90 of a driving device 30 has different amounts of gears; the gear set 90 is provided thereon with a servomotor 70. And a material receiving cylinder 20 of the present invention is provided on its upper end with an outer screw thread 80, the driving device 30 is provided on its bottom end with an inner screw thread 81, so that the material receiving cylinder 20 and the driving device 30 can be screw connected with each other. The above screw-connecting structure can also be applied to the first and the second embodiment.

The present invention thereby has the following advantages:

1. when in operation of the present invention, by combining of electric and mechanical means, and by the pushing action of a screw rod, the distance of displacement of forwarding of the material pusher piston is kept constant, thus in adhesive dripping, the outputting amount of adhesive can be accurately controlled.

2. the present invention controls the outputting amount of adhesive by means of a controller and a driving device, it does not use an air compressor, space needed can be reduced, it is convenient for carrying, and can prevent generation of waste gas, no air pollution is created, and thereby the present invention can be used in a dustless operation environment.

In conclusion, according to the description disclosed above, the present invention surely can get the expected object thereof to provide an adhesive dripping machine convenient for carrying, able to accurately control the amount of adhesive flow and to be used in a dustless operation environment; the present invention has practical value.

While the above stated transmitting structure including a servomotor and a link is only for illustrating the present invention, and not for giving any limitation to the scope of the present invention; it will be apparent to those skilled in this art that various modifications or changes to push the pusher piston to displace for a fixed distance and to control the work of adhesive dripping without departing from the spirit of this invention shall also fall within the scope of the appended claims.

1. An adhesive dripping machine comprising:
a cylinder for receiving liquid material, an upper end of said cylinder has a first engaging portion, and a bottom end of said cylinder has a material outlet nozzle;
a driving device provided above said cylinder and having a second engaging portion engaged with said first engaging portion;
a material pusher piston provided in said cylinder and having a link on one end thereof, said piston is driven by said driving device to create axial displacement in said cylinder; and
a controller electrically connecting with said driving device;
by combination of the above elements, said controller controls said driving device to make said material pusher piston move frontwards and rearwards in the cylinder; when said material pusher piston moves forwards, said liquid material in said cylinder is extruded out of said material outlet nozzle; when said material pusher piston is retracted rearwards, by attraction of said piston, said liquid material does not go on to drip down, and by controlling said material pusher piston to displace for a fixed distance, the work of adhesive dripping is accurately performed.

2. The adhesive dripping machine as in claim 1, wherein said driving device is a servomotor having therein a rotator provided with an inner screw thread.

3. The adhesive dripping machine as in claim 1, wherein said link of said material pusher piston is a screw rod which is directly or

4. The adhesive dripping machine as in claim 2, wherein said link of said material pusher piston is a screw rod which is directly or indirectly driven by said rotator.

5. The adhesive dripping machine as in claim 1, wherein said driving device includes a servomotor, a gear set and a connecting rod to connect and drive said link of said material pusher piston.
